(19) United States
(12) Patent Application Publication
(10) Pub. No.: US 2016/0015110 A1
(43) Pub. Date: Jan. 21, 2016

(54) SOLAR-POWERED SIGNALING DEVICE

(71) Applicant: SZM Taiwan Co., Ltd., New Taipei City (TW)

(72) Inventor: Shian Chao, New Taipei City (TW)

(21) Appl. No.: 14/333,513

(22) Filed: Jul. 17, 2014

(51) Int. Cl. A42B 3/04; H02J 7/35; B60Q 1/26; G08B 5/36

(52) U.S. Cl. CPC A42B 3/0453; G08B 5/36; H02J 7/35; B60Q 1/2676

(57) ABSTRACT

The solar-powered signaling device contains a controller, a solar panel, and a display. The controller receives electricity from at least an external power source and delivers electricity and a text message. The solar panel and the display are electrically connected to the controller. The controller can be configured inside a helmet, and the solar panel and the display are attached to an outer surface of the helmet. The electricity produced by the solar panel is delivered to the controller which in turn powers the display. The display therefore is capable of showing the text message delivered by the controller. A motorcycle driver or a bicycle rider can wear the helmet showing a precaution text message to alert another driver or rider in the rear so as to achieve enhanced safety.

### BACKGROUND OF INVENTION

(a) Technical Field of the Invention

The present invention is generally related to solar-powered signaling devices, and more particular to a solar-powered signaling device configured on a motorcycle or bicycle helmet to alert a driver or rider in the rear.

(b) Description of the Prior Art

Existing automobiles have large tail lights and even a third brake light, and therefore are more visible and safer from rear-end collision. In contrast, existing motorcycles, due to their limited form factors, can only have small indicator lights at the rear end. They are therefore much less visible, especially during the night. As to bicycles, their slim frames can only allow even smaller, reflection-type indicators. Motorcycle drivers and bicycle riders as such suffer a greater risk when they are on the road, and their risk is even higher during the night.

### SUMMARY OF THE INVENTION

The present invention therefore teaches a novel solar-powered signaling device for a motorcycle or bicycle helmet, which contains the following components.

There is a controller receiving electricity from at least an external power source and delivering electricity and a text message.

There is at least a solar panel having a power cable connected to the controller. The electricity produced by the solar panel is delivered to the controller via the power cable.

There is at least a display having a transmission cable connected to the controller. The electricity and text message delivered by the controller are transmitted to the display via the transmission cable.

Therefore, the electricity produced by the solar panel is delivered to the controller which in turn powers the display. The display therefore is capable of showing the text message delivered by the controller. The signaling device can be configured on a helmet so that a motorcycle driver or a bicycle rider can wear the helmet showing a precaution text message to alert another driver or rider in the rear so as to achieve enhanced safety.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become apparent to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic diagram showing a signaling device according to an embodiment of the present invention.

FIG. 2 is a schematic diagram showing the signaling device of FIG. 1 under operation.

FIG. 3 is a schematic diagram showing the signaling device of FIG. 1 connected to the mains.

FIG. 4 is a schematic diagram showing the signaling device of FIG. 1 configured on a helmet.

FIG. 5 is a schematic diagram showing the signaling device of FIG. 1 configured on another helmet.

FIG. 6 is a schematic diagram showing an application scenario of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

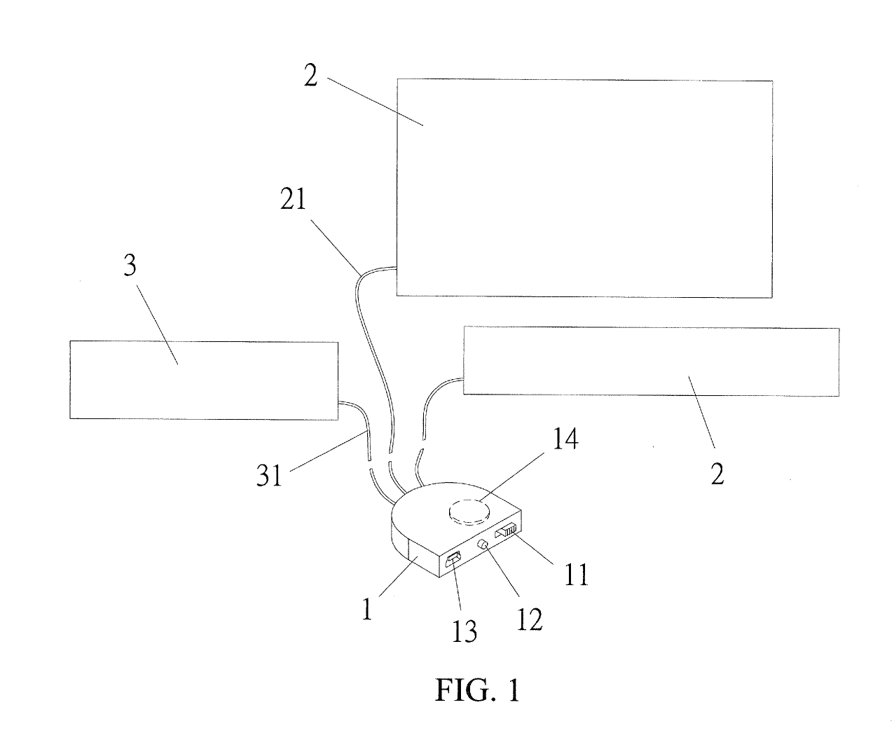

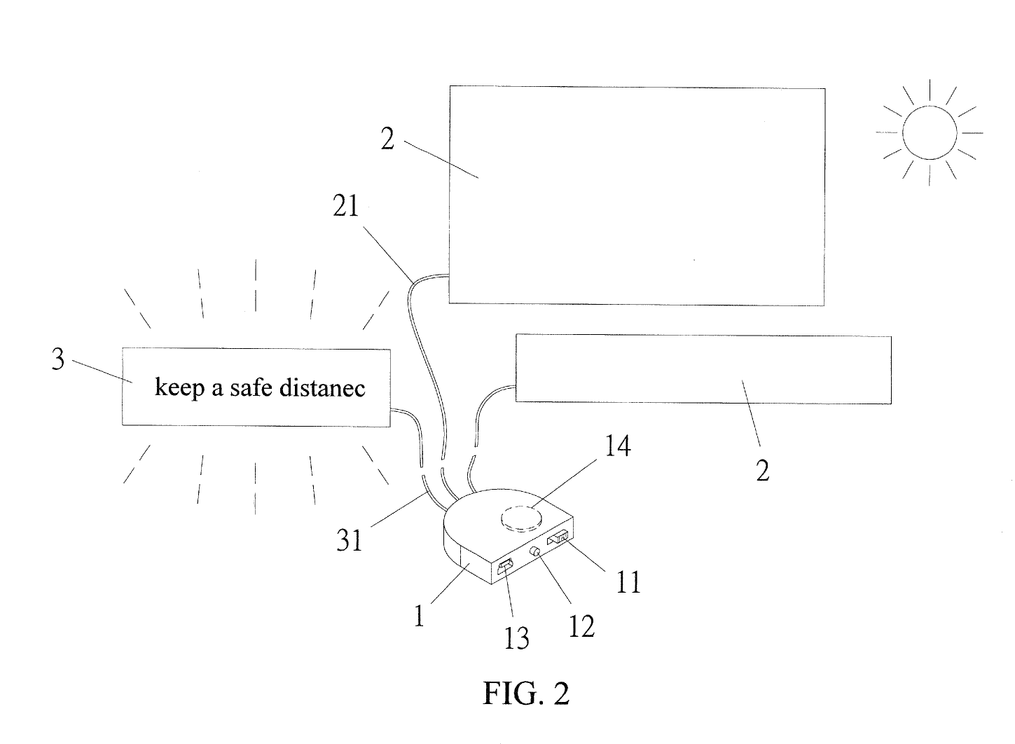

As shown in FIGS. 1 and 2, a solar-powered signaling device for a helmet according to an embodiment of the present invention contains the following components.

There is a controller 1 receiving electricity from at least an external power source and delivering electricity and a text message. The controller 1 has an on/off switch 11, a message selection button 12, and a power connector 13, all on a casing of the controller 1. The controller 1 also has a control circuit (not shown) and a battery 14 inside. The on/off switch 11, the message selection button 12, the power connector 13, and the battery 14 are electrically connected to the control circuit. Pressing the message selection button 12 triggers the controller 1 to produce different text messages.

There is at least a solar panel 2 having a power cable 21 connected to the controller 1. The electricity produced by the solar panel 2 is as such delivered to the controller 1 via the power cable 21. More specifically, the power cable 21 is connected to the control circuit of the controller 1 and the control circuit charges the battery 14 with the electricity received from the power cable 21.

There is at least a display 3 having a transmission cable 31 connected to the controller 1. The electricity and text message delivered by the controller 1 are transmitted to the display 3 via the transmission cable 31. The display 3 can be an array of LEDs or a LCD panel. More specifically, the transmission cable 31 is connected to the control circuit of the controller 1, the electricity delivered from the controller 1 powers the display 3, and the display 3 shows the text message, as illustrated in FIG. 2.

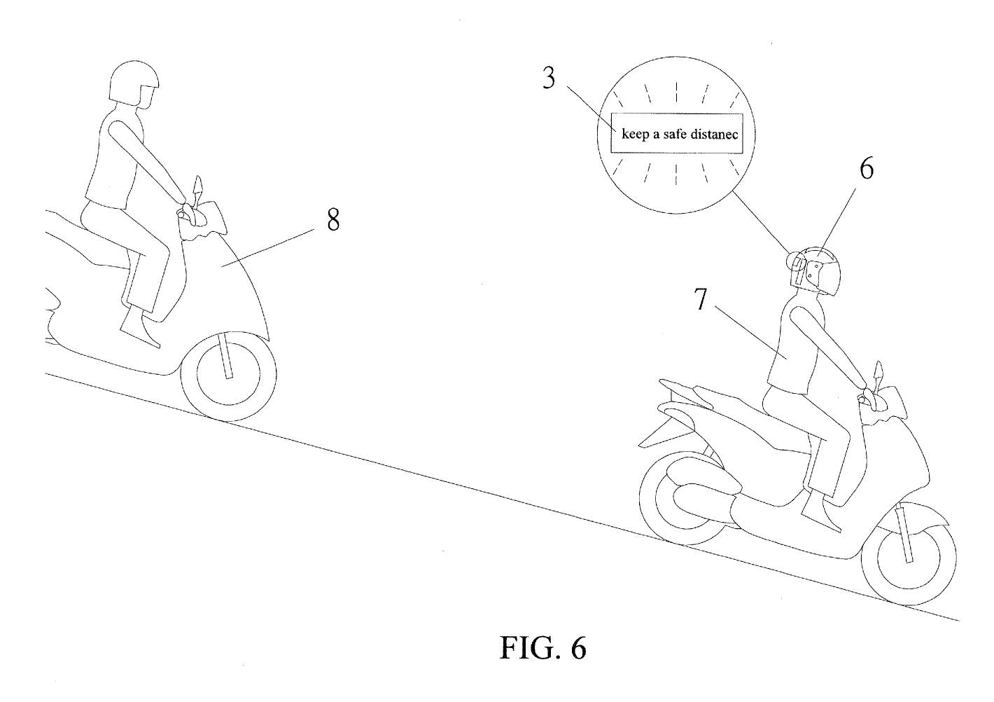

Therefore, the electricity produced by the solar panel 2 is delivered to the controller 1 which in turn powers the display 3. The display 3 therefore is capable of showing the text message delivered by the controller 1. A user can press the message selection button 12 so that the display 3 shows a desired text message such as a traffic precaution message or a marketing message. As shown in FIG. 6, a driver in the rear can clearly see the text message shown.

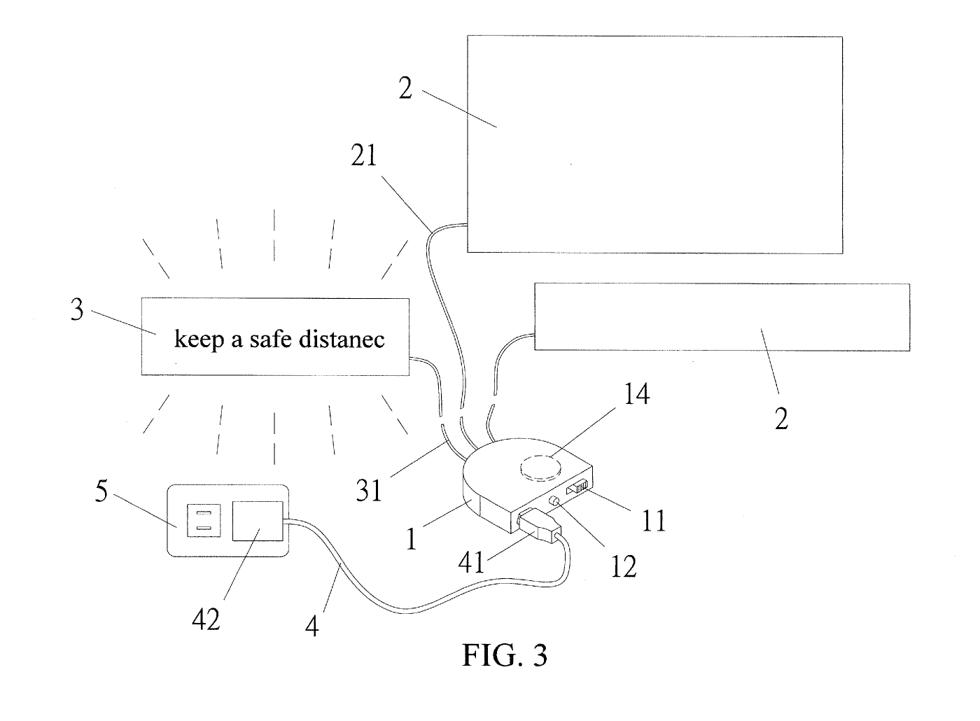

As shown in FIG. 3, the controller 1 can be connected to the mains through another power cable 4 which has a connector 41 at one end and a plug 42 at the other end. The connector 41 is joined to the power connector 13 of the controller 1 and the plug 42 is plugged into a wall socket 5. The power connector 13 is electrically connected to the controller 1 and the electricity from the mains is delivered to the control circuit. With the electricity from the mains, the controller 1 charges the battery 14, powers the display 3, and delivers a text message for the display 3 to show.

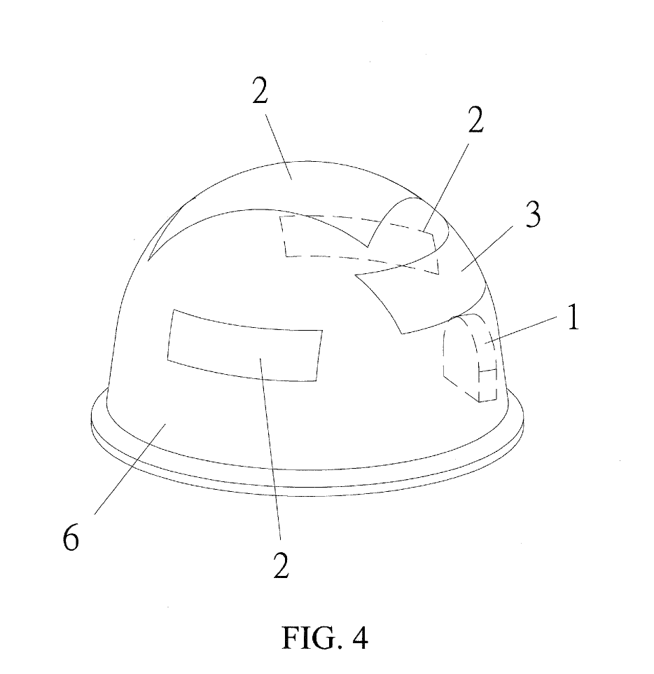

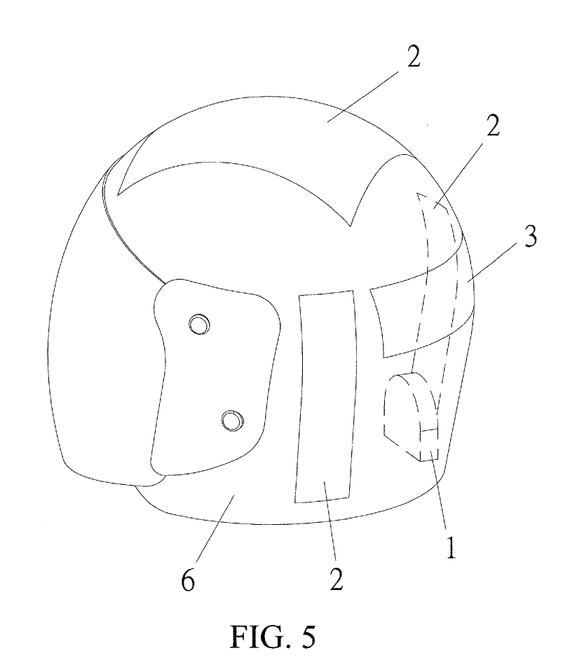

As shown in FIG. 4, the controller 1 can be configured inside a helmet 6 and the solar panel 2 and the display 3 are attached to an outer surface of the helmet 6. As shown in FIGS. 4 and 5, the helmet 6 can be of different styles (such as a full face helmet or an open face helmet). The solar panel 2 can be fixed to a top side, a lateral side, or a combination of sides of the helmet 6. The display 3 can be fixed to a rear side of the helmet 6.

As shown in FIG. 6, a motorcycle driver 7 can wear the helmet 6 showing a precaution text message such as “keep a safe distance” to alert the driver of another motorcycle 8 in the rear so as to achieve enhanced safety especially during the night.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A solar-powered signaling device configured on a helmet, comprising:
a controller receiving electricity from at least an external power source and delivering electricity and a text message;
at least a solar panel having a power cable connected to the controller where the electricity produced by the solar panel is delivered to the controller via the power cable; and
at least a display having a transmission cable connected to the controller where the electricity and text message delivered by the controller are transmitted to the display via the transmission cable, and the display shows the message;
wherein the controller is configured inside the helmet; and the solar panel and the display are attached to an outer surface of the helmet.

2. The solar-powered signaling device according to claim 1, wherein the controller comprises an on/off switch, a message selection button, a power connector, all on a casing of the controller, and a control circuit and a battery, both inside the controller; and the on/off switch, the message selection button, the power connector, and the battery are all electrically connected to the control circuit.

3. The solar-powered signaling device according to claim 2, wherein the power connector is for connection to the mains via a second power cable; the second power cable has a connector at one end and a plug at the other end; the connector is joined to the power connector; and the plug is plugged into a mains socket.

4. The solar-powered signaling device according to claim 1, wherein the solar panel is fixed to a top side or a lateral side of the helmet;
and the display is fixed to a rear side of the helmet.

5. The solar-powered signaling device according to claim 1, wherein the display is an array of LEDs.

6. The solar-powered signaling device according to claim 4, wherein the display is an array of LEDs.

7. The solar-powered signaling device according to claim 1, wherein the display is a LCD panel.

8. The solar-powered signaling device according to claim 4, wherein the display is a LCD panel.
